(19) United States
(12) Patent Application Publication
(10) Pub. No.: US 2008/0260329 A1
(43) Pub. Date: Oct. 23, 2008

(54) LIGHTGUIDES HAVING CURVED LIGHT INJECTORS

(75) Inventor: Kenneth A. Epstein, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/738,186

(22) Filed: Apr. 20, 2007

(51) Int. Cl. G02B 6/26

(52) U.S. Cl. 385/32

(57) ABSTRACT

An optical system has a lightguide having a confinement direction and a first light source disposed proximate a periphery of the lightguide. A light injector is disposed to couple light from the first light source into the lightguide. The light injector has a surface formed with a confinement curve for confining light in the confinement direction. The light injector may be disposed at either a recess on the periphery of the lightguide or at a cut corner of the lightguide. A refractive structure, having at least one surface non-perpendicular to an emission axis of the light source may be disposed between the injector and the lightguide. At least a portion of the injector may have a shape corresponding to a confinement curve that is rotated about an axis parallel to the confinement direction.

### FIELD OF THE INVENTION

The invention relates to lightguides that are used, for example, for illuminating a display, and more particularly to methods and devices for injecting light into the lightguides from light emitting diodes.

### BACKGROUND

The light emitting diode (LED) first gained entry to backlighting liquid crystal displays (LCDs) in small handheld displays. Such backlights typically comprise a lightguide with one or more white LEDs configured to inject light into one edge or one corner of the lightguide. Surface mount side-emitting LEDs for handheld backlights typically have an emission aperture 0.6 to 0.8 mm in height. Thus, the thinnest lightguide that will accept all of the light is 0.6 mm or thicker.

In a handheld backlight the LED package is oriented beside the input edge of the lightguide and the light is coupled through air from the LED to the lightguide. An optical scattering surface is patterned on the bottom of the lightguide to extract light by directing the light upwards to the liquid crystal panel. Up to 90% of the light incident on the lightguide input edge refracts from air into the lightguide. However, the optical spread angle for propagation in the plane of the lightguide is limited by the critical angle of light in the lightguide. Thus, the light that enters through the edge of a lightguide spreads out within the lightguide with a half angle of 42° with respect to the normal to the edge of the lightguide. Therefore, the light spreads weakly and uniformity suffers.

Many handheld lightguides are manufactured with a structured input edge. The structure is typically a micro-columnar lens, prism, or other lenticular grooves running from the top surface to the bottom surface of the lightguide. Such grooves tend to spread light into a propagation cone wider than the critical angle, but still less than 90-degrees. Hence, the need still exists for greater propagation divergence in the lightguide.

Recently, implementation of solid state lighting began transitioning to larger displays, such as notebooks, monitors, and TVs with either white LEDs or RGB LEDs. In each instance, from handheld up to the largest TVs, the backlight is built to accommodate a large LED package with a substantial encapsulant optic. The accommodation typically results in a thick backlight and a large region dedicated to mixing the light from individual LEDs into homogeneous white light. In particular, edgelit displays require a mixing region up to 100 mm long. Thus, a substantial portion of the backlight must extend beyond the display area within a wide bezel or it may fold under the display area so as to ensure that the mixing region lies outside the viewing area of the display.

Three deficiencies of conventional approach may be summarized as:
1. Air-coupling from the LED package into the lightguide restricts the angles of injected light to a propagation cone bounded by the critical angle of the lightguide; therefore, the light mixing region in the lightguide is lengthened.
2. The standard LED packages are large; therefore the emitted light does not couple efficiently into a thin lightguide.
3. The refractive index of the encapsulant is typically much lower than that of the emissive die; therefore the extraction of light from the die is inefficient.

### SUMMARY OF THE INVENTION

One embodiment of the invention is directed to an optical system that has a lightguide having a confinement direction and a first light source disposed proximate a periphery of the lightguide. Light from the first light source is directed substantially around an emission axis which is perpendicular to the confinement direction. A first light injector is disposed to couple light from the first light source into the lightguide. The first light injector has a surface formed with a confinement curve for confining light in the confinement direction. Also, the first light injector is disposed at one of a recess on the periphery of the lightguide and a cut corner of the lightguide.

Another embodiment of the invention is directed to an optical system having a first light emitting diode capable of emitting light generally about an emission axis and a lightguide having a confinement direction substantially perpendicular to the emission axis. A first injector couples light from the first light emitting diode to the lightguide. The first injector has confinement curve-shaped surfaces shaped so as to confine light in a direction parallel to the confinement direction of the lightguide. A refractive structure is disposed between the first injector and the lightguide, the refractive structure having at least one surface non-perpendicular to the emission axis of the light emitting diode.

Another embodiment of the invention is directed to an optical system that has a first light emitting diode capable of emitting light generally about an emission axis, and a lightguide having a confinement direction substantially perpendicular to the emission axis. A first injector couples light from the first light emitting diode to the lightguide. The first injector has confinement curve-shaped surfaces shaped so as confine light in a direction parallel to the confinement direction of the lightguide. At least a portion of the first injector has a shape corresponding to a confinement curve that is rotated about an axis parallel to the confinement direction.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of a display system having an edge-lit backlight, according to principles of the present invention;

FIG. 2A schematically illustrates injection of light from a light emitting diode (LED) into a lightguide using a confinement curve injector according to principles of the present invention;

FIGS. 2B and 2C schematically illustrate different geometries of LEDs used with an embodiment of a confinement curve injector according to principles of the present invention;

FIG. 3 presents a graph showing sample critical curves for an injector having different values of refractive index;

FIG. 4 schematically illustrates an embodiment of a semicircular confinement curve injector used with an LED and lightguide according to principles of the present invention;

FIG. 5 schematically illustrates an embodiment of a stretched semicircular confinement curve injector used with an LED and lightguide according to principles of the present invention;

FIG. 6 schematically illustrates an embodiment of a stretched corner confinement curve injector used with an LED and lightguide according to principles of the present invention;

FIG. 7 schematically illustrates an embodiment of a straight corner confinement curve injector used with an LED and lightguide according to principles of the present invention;

FIG. 8 schematically illustrates an embodiment of a stretched semicircular confinement curve injector having a V-notched output face, used with an LED and lightguide according to principles of the present invention;

FIG. 9 schematically illustrates an embodiment of a stretched semicircular confinement curve injector having a cylindrically notched output face, used with an LED and lightguide according to principles of the present invention;

FIGS. 10A and 10B schematically illustrate models used for calculating the effectiveness of various embodiments of confinement curve injectors;

FIGS. 11-16 present calculated results showing the spread of light within a lightguide when the light is injected to the lightguide using different embodiments of confinement curve injectors; and

FIG. 17 presents calculated results showing the spread of light within a lightguide where the LED is coupled directly to the lightguide without a confinement curve injector.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to optical display systems in which the display panel is illuminated from behind using a lightguide. In such displays, the light source or sources, is placed to the side of the display panel and the lightguide is used to transport the light from the light source(s) to positions behind the display panel. The invention relates to an approach for coupling light into the lightguide from a light source, such as a light emitting diode (LED).

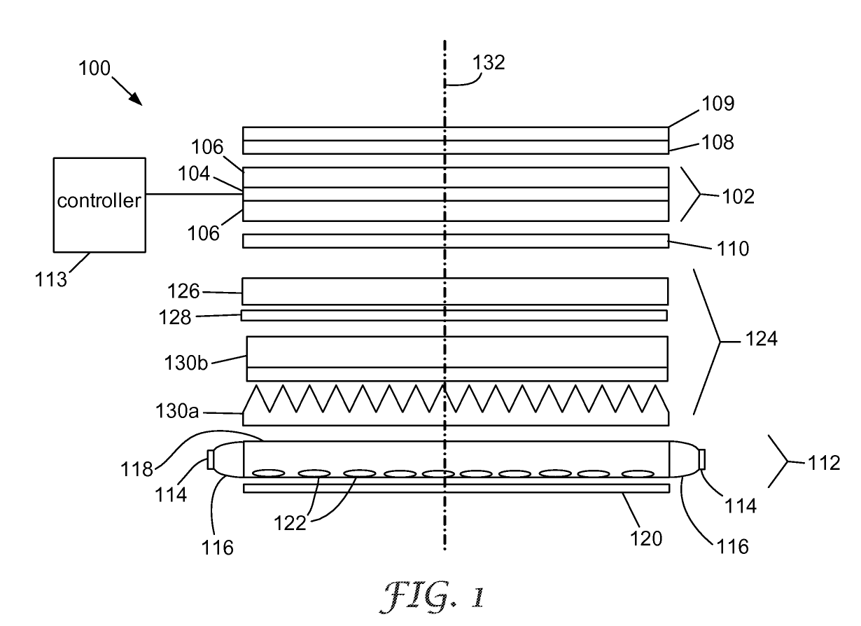

A schematic exploded view of an exemplary embodiment of an edge-lit display device 100 is presented in FIG. 1. In this exemplary embodiment, the display device 100 uses a liquid crystal (LC) display panel 102, which typically comprises a layer of LC 104 disposed between panel plates 106. The plates 106 are often formed of glass, or another stiff material, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent pixels. A color filter may also be included with one or more of the plates 106 for imposing color on the displayed image.

An upper absorbing polarizer 108 is positioned above the LC layer 104 and a lower absorbing polarizer 110 is positioned below the LC layer 104. In the illustrated embodiment, the upper and lower absorbing polarizers 108, 110 are located outside the LC panel 102. The absorbing polarizers 108, 110 and the LC panel 102, in combination, control the transmission of light from a backlight 112 through the display 100 to the viewer. In some exemplary embodiments, when a pixel of the LC layer 104 is not activated, it does not change the polarization of light passing therethrough. Accordingly, light that passes through the lower absorbing polarizer 110 is absorbed by the upper absorbing polarizer 108, when the absorbing polarizers 108, 110 are aligned perpendicularly. When the pixel is activated, on the other hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 113, results in the light passing out of the display at certain desired locations, thus forming an image seen by the viewer. The controller 113 may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

Some types of LC displays may operate in a manner different from that described above and, therefore, differ in detail from the described system. For example, the absorbing polarizers may be aligned parallel and the LC panel may rotate the polarization of the light when in an unactivated state. Regardless, the basic structure of such displays remains similar to that described above.

The backlight 112 comprises one or more light sources 114 that generate the illumination light and direct the illumination light into a lightguide 118. The light sources 114 may be, for example, light emitting diodes (LEDs). Light from the light sources 114 may be coupled into the lightguide 118 by an injector 116, which is described in greater detail below. The lightguide 118 guides illumination light from the light sources 114 to an area behind the display panel 102, and directs the light to the display panel 102. The lightguide 118 may receive illumination light through one or more edges, one or more corners, or a combination of edges and corners.

A base reflector 120 may be positioned on the other side of the lightguide 118 from the display panel 102. The lightguide 118 may include light extraction features 122 that are used to extract the light from the lightguide 118 for illuminating the display panel 102. For example, the light extraction features 122 may comprise bumps or diffusing spots on a surface of the lightguide 118 that direct light either directly towards the display panel 102 or towards the base reflector 120. Other approaches may be used to extract the light from the lightguide 118.

The base reflector 120 may also be useful for recycling light within the display device 100, as is explained below. The base reflector 120 may be a specular reflector or may be a diffuse reflector.

An arrangement of light management layers 124 may be positioned between the backlight 112 and the display panel 102 for enhanced performance. For example, the light management layers 124 may include a reflective polarizer 126. The light sources 116 typically produce unpolarized light but the lower absorbing polarizer 110 only transmits a single polarization state, and so about half of the light generated by the light sources 116 is not suitable for transmission through to the LC layer 104. The reflecting polarizer 126, however, may be used to reflect the light that would otherwise be absorbed in the lower absorbing polarizer 110, and so this light may be recycled by reflection between the reflecting polarizer 126 and the base reflector 120. At least some of the light reflected by the reflecting polarizer 126 may be depolarized and subsequently returned to the reflecting polarizer 126 in a polarization state that is transmitted through the reflecting polarizer 126 and the lower absorbing polarizer 110 to the LC panel 102. In this manner, the reflecting polarizer 126 may be used to increase the fraction of light emitted by the light sources 116 that reaches the LC panel 102, and so the image produced by the display device 100 is brighter.

Any suitable type of reflective polarizer may be used, for example, multilayer optical film (MOF) reflective polarizers; diffusely reflective polarizing film (DRPF) such as continuous/disperse phase polarizers; wire grid reflective polarizers; or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. Nos. 5,882,774, incorporated herein by reference. Commercially available examples of MOF reflective polarizers include Vikuiti™ DBEF-D200 and DBEF-D400 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of wire grid polarizers useful in connection with the present invention include those described in U.S. Pat. No. 6,122,103. Wire grid polarizers are commercially available from, inter alia, Moxtek Inc., Orem, Utah.

Some examples of cholesteric polarizers useful in connection with the present invention include those described in, for example, U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

A polarization mixing layer 128 may be placed between the backlight 112 and the reflecting polarizer 126 to aid in mixing the polarization of the light reflected by the reflecting polarizer 126. For example, the polarization mixing layer 128 may be a birefringent layer such as a quarter-wave retarding layer.

The light management layers 124 may also include one or more prismatic brightness enhancing layers 130a, 130b. A prismatic brightness enhancing layer is one that includes a surface structure that redirects off-axis light into a propagation direction closer to axis 132 of the display device 100. This controls the viewing angle of the illumination light passing through the display panel 102, typically increasing the amount of light propagating on-axis through the display panel 102. Consequently, the on-axis brightness of the image seen by the viewer is increased.

One example of a brightness enhancing layer has a number of prismatic ridges that redirect the illumination light, through a combination of refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. Although only one brightness enhancing layer may be used, two brightness enhancing layers 130a, 130b may be used, with their structures oriented at about 90° to each other. This crossed configuration provides control of the viewing angle of the illumination light in two dimensions, the horizontal and vertical viewing angles.

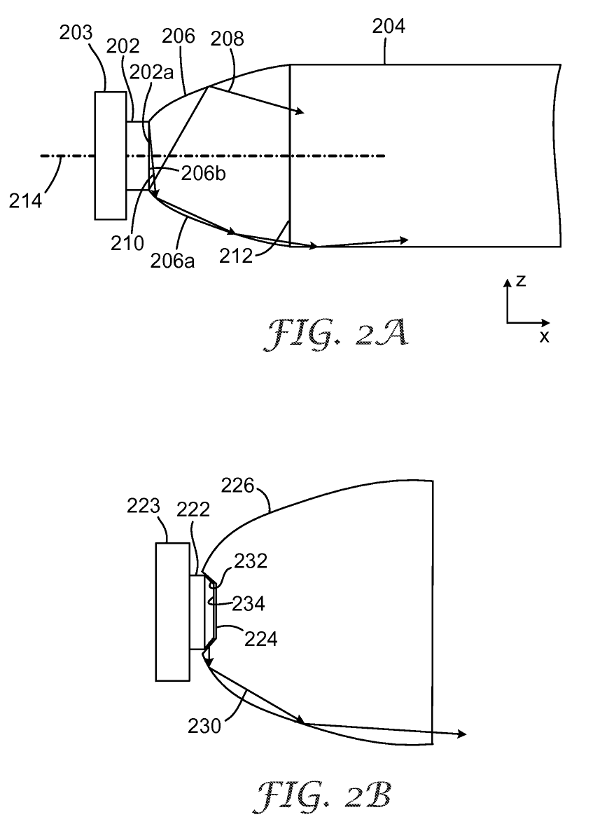

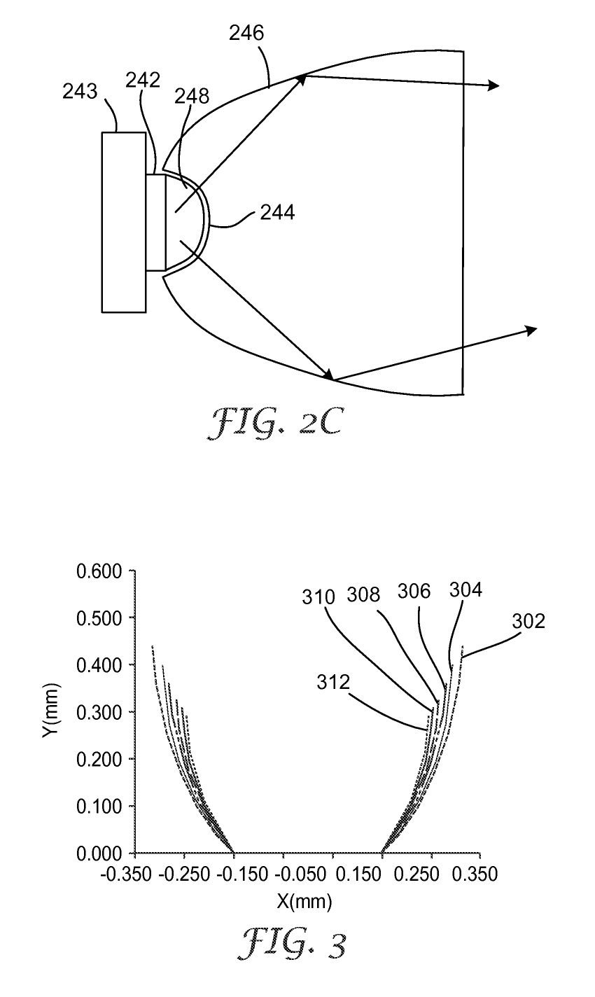

FIG. 2A schematically illustrates a cross-section of an LED 202 coupled to the edge of a lightguide 204 via a confinement curve injector 206. Light 208 emitted by the LED 202 enters the injector 206. The injector 206 may be formed from any suitable transparent material, e.g. glass materials including optical glasses such as Schott glass type LASF35 or N-LAF34, available from Schott North America Inc., and those described in U.S. patent application Ser. No. 11/381,518, incorporated herein by reference. Other suitable inorganic materials include ceramics such as sapphire, zinc oxide, zirconium oxide and silicon carbide. Examples of suitable organic materials include polymers such as acrylics, epoxies, silicones, polycarbonates, and cyclic olefins. Polymeric materials may include dopants, for example ceramic nanoparticles as discussed in U.S. Provisional Patent Application Ser. No. 60/866,280, filed Nov. 17, 2006. This list of materials is not intended to be exhaustive and other types of glasses, ceramics and polymers may also be used.

The injector 206 includes sidewalls 206a that are shaped with a curve that is referred to as a confinement curve. In other words, light incident on the wall 206a from the far side of the LED 202, for example ray 210, is incident at the sidewall 206a at such an angle that the light 210 is totally internally reflected at the sidewall. Light emitted from a closer point on the LED 202 is incident at the same point on the sidewall 206a at a higher angle of incidence and is, therefore, also totally internally reflected. Consequently, Lambertian light transmitted from the LED 202, which may be in the form of a die, is confined by total internal reflection (TIR) within the injector 206 and is presented at the output aperture 212 for coupling into the lightguide 204. The interface between the output 212 of the injector 206 and the lightguide 204 may be air-filled or may be filled with some other material, for example an index matching fluid or polymer, such as a gel, oil, adhesive, or pressure sensitive adhesive.

Any suitable type of LED may be attached to an injector. For example, a flip-chip die, where the electrical tabs are both on the back of the die, may be attached via its light emitting surface, while maintaining easy electrical contact. In the case of wire bonded LED die, the wire at the light emitting side may reside in an elastomeric medium such as silicone, which provides relief from thermo-mechanical stress.

In the embodiment schematically illustrated in FIG. 2A, the LED die 202 is attached to a mount 203 which may be, for example, a circuit board, or may include a submount on a circuit board. Typically, the mount 203 provides electrical power to the LED die 202 and may also provide some thermal management capability. For example, the mount 203 may act as a heatsink, either passive or active, for the LED die 202.

The light emitting surface 202a of the LED die 202 is optically coupled to the input surface 206b of the injector 206. The light emitting surface 202a may be simply placed in contact with the input surface 206b, or there may be some coupling material between the light emitting surface 202a and the input surface 206b. For example, the coupling material may be an encapsulating material.

Different types of LED may be used in this embodiment and in the embodiments described below. For example, the LED may be a flip-chip LED die, where both electrical contacts are on the surface of the LED die 202 facing the mount 203, or may be a wire-bonded LED die, in which case one of the electrical contacts is on the side of the LED die 202 facing the injector 206.

In some embodiments, the light may be emitted from an edge of the LED. This situation is schematically illustrated in FIG. 2B. The LED die 222 is attached to a mount 223 and is disposed within a recess formed by a recessed input surface 224 of the injector 226. The recessed input surface 224 may be shaped to conform to the shape of the LED die 222, although this is not a requirement. In this embodiment, light 230 is emitted from the edge surfaces 232 of the LED die 220, and may also be emitted from the upper surface 234. A coupling material may also be disposed between the LED die 220 and the recessed input surface 224 of the injector 228.

In some embodiments, the LED may be encapsulated, rather than being a naked LED die. This situation is schematically illustrated in FIG. 2C, in which the encapsulated LED 242, which is attached to a mount 243, is disposed at least partially within a recess formed by recessed input surface 244 of the injector 246. The recessed input surface 244 may be shaped to conform to the shape of the encapsulant 248 of the LED 240, although this is not a requirement. A coupling material may also be disposed between the encapsulated LED 242 and the recessed input surface 244 of the injector 248.

In some embodiments, a phosphor may be included to convert the wavelength of at least some of the light emitted by the LED. For example, a blue LED may be provided with a phosphor that produces a yellow light, so that the combination of blue and yellow light appears to the viewer as white light. The phosphor may be provided on the LED or as a layer between the LED and the injector. In other embodiments, the LED may comprise a plurality of different diode junctions that emit light at different wavelengths, for example red, green and blue light to produce light that is perceived as being white light by the viewer. For example, the LED may comprise different LED dies emitting at different colors.

The lightguide 204 provides optical confinement in the z-direction, permitting light to propagate in the x and y directions. In this case, the z-direction is referred to as the confinement direction. An emission axis 214 defines an average direction of light emitted from the LED 202. In embodiments of LED 202 where the emitting surface 202a is substantially flat, the emission axis 214 is generally perpendicular to the emitting surface. Thus, when the plane of the emitting surface 202a lies parallel to the confinement direction, the emission axis lies perpendicular to the confinement direction.

The sidewalls 206a of the injector 206 have a confinement curve that presents a reflecting surface shaped so that light emitted from the farthest part of the LED die is incident at all points on the sidewalls 206a at an angle that is greater than the critical angle for light propagating from that part. A critical curve may be built incrementally from line segments beginning at the region closest to the LED 202 die by requiring the segments to tilt at an angle just within the critical angle for light emitted from the opposing corner of the LED die 202. The length of each segment is short enough such that the resulting injector body confines light by TIR along the entire surface. In practice, it may be possible to build a mold from faceted segments or a continuous curve. Light emitted from the full surface of the LED die 202 is ensured to be totally internally reflected at the sidewalls 206a using this procedure. The injector 206 is more compact when the refractive index of the injector material is higher. When the curve of the injector sidewalls 206a is a critical curve, the dimensions of the injector 206 optic are the minimum for a body that confines light entirely by total internal reflection. The dimensions scale according to the size of the LED die 202.

Some shapes of couplers attached to LED die, such as parabolic concentrators and elliptical concentrators, normally require reflective surfaces to confine light, since they do not totally internally reflect all the light. Such couplers, typically have rotational symmetry around a normal to the LED's emitting surface or translational symmetry in one direction of the die surface. Other devices use a TIR reflective cusp, which has rotational symmetry around the LED normal or translational symmetric in one direction of the die surface. The present invention has different symmetries with respect to the die, as will become evident below. Moreover, the present invention relates to improvement of the propagation divergence of light in an edge-illuminated lightguide, which is an improvement over the prior art.

Another feature of the injector is the ability to effectively “index match” light propagating from the LED to the lightguide. The use of an injector that is separate from the lightguide permits the selection of a material having a refractive index whose value lies between the refractive indices of the LED and the lightguide. For example, where the LED has a relatively high refractive index, and the lightguide has a relatively low refractive index, the refractive index of the injector may be selected to have a value between those for the LED and the lightguide. Judicious selection of the refractive index of the injector material may also lead to a reduction in reflective losses, increasing the overall amount of light reaching the lightguide.

In this document, when an injector is shaped so all emission directions of light from the LED are incident at the curved sidewall of the injector at an angle equal to or greater than the critical angle, then the injector is referred to as a confinement curve injector. FIG. 3 contains a graph that shows different critical curves for a injector having a 300 μm square input face, where the injector is made of materials having different refractive indices. Curve 302 is associated with a refractive index of 1.45, curve 304 is associated with a refractive index of 1.5, curve 306 is associated with a refractive index of 1.55, curve 308 is associated with a refractive index of 1.6, curve 310 is associated with a refractive index of 1.65, and curve 312 is associated with a refractive index of 1.7.

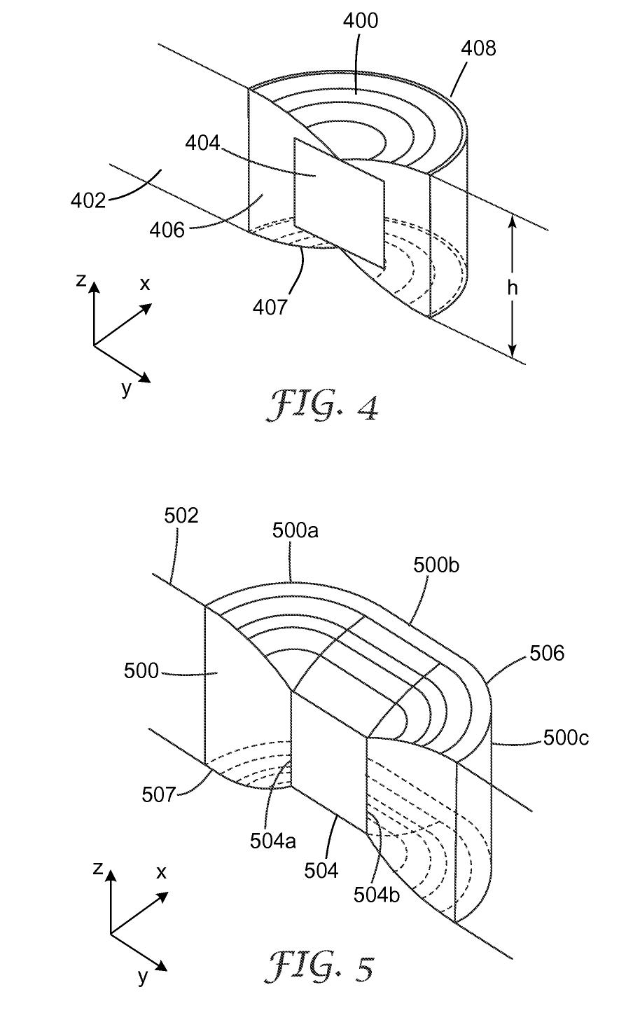

One exemplary embodiment of a confinement curve injector 400 is schematically illustrated in FIG. 4. The injector 400 is positioned by the edge of a lightguide 402. An LED die 404 is attached to the input side 406 of the injector 400. The injector 400 may be coupled to the lightguide 402 via an air gap, via directly contacting surfaces or via an intermediate coupling material. In other embodiments, the injector 400 may be integrally formed with the lightguide 402. For example, the injector 400 may be a molded portion of the lightguide 402. The shape of the injector 400 is produced by rotating a confinement curve 407 about an axis that is parallel to the z-axis, i.e. that is parallel to the confinement direction of the lightguide 402, through an angle of 180°. The injector 400 may sit in a recess 408 on the edge of the lightguide 402 that conforms to the shape of the injector 400. In embodiments where the injector 400 is formed integrally with the lightguide 402, the recess 408 may be considered to be the region where the injector's confinement curve surface meets the flat surface of the lightguide 402. Those regions of the input side 406 of the injector 400 that lie outside the periphery of the LED 404 may be reflective, for example may be provided with a reflective coating.

The thickness of the lightguide 402 in the confinement direction is shown as h. An advantage provided by the injector 400 over placing an LED flat against the edge of the lightguide is that light emitted from the LED with a direction component in the +z or −z direction is trapped in the injector and lightguide. In the case where no injector is present, some of the light emitted with a +z or −z direction component may be incident on the upper or lower surface of the lightguide at an angle less than the critical angle and, therefore, leak out of the lightguide.

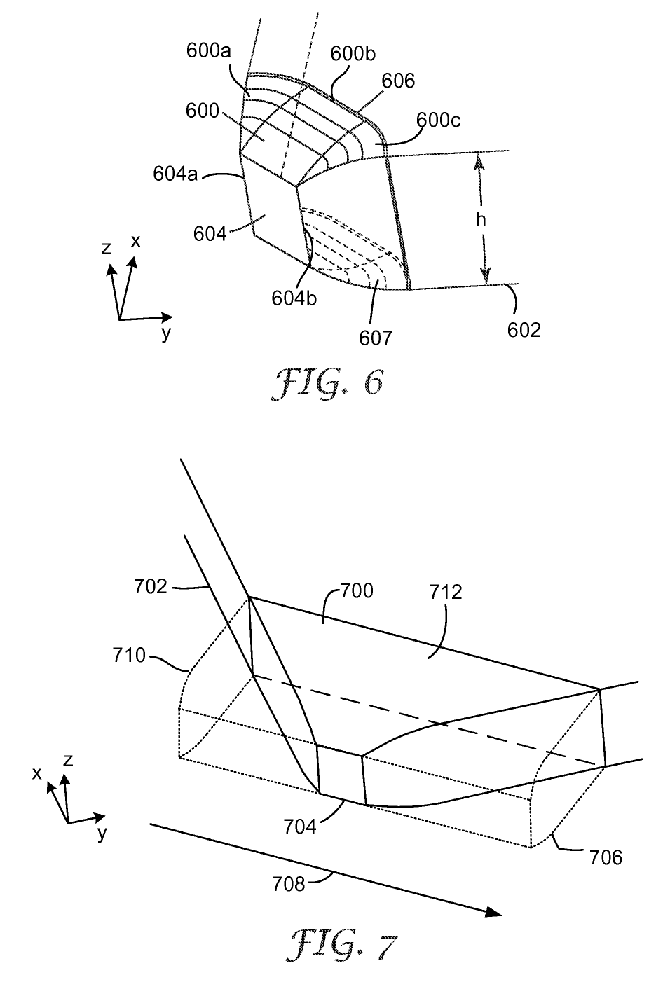

Another embodiment of confinement curve injector 500 for coupling light from an LED die 504 into a lightguide 502 is schematically illustrated in FIG. 5. The injector 500 is positioned by the edge of the lightguide 502. The injector 500 may be coupled to the lightguide 502 via an air gap, via directly contacting surfaces or via an intermediate coupling material. In this embodiment, the injector 500 is formed from three parts. The first part 500a corresponds to a shape produced by rotating a confinement curve 507 about an axis that is parallel to the z-axis (parallel to the confinement direction) and positioned at the left edge 504a of the LED 504. The first part 500a corresponds to the confinement curve 507 being rotated about the axis through an angle of 90°. The second part 500b corresponds to a shape produced by translating the confinement curve 507 in a direction parallel to the y-axis along the width of the LED 504. The third part 500c corresponds to a shape produced by rotating the confinement curve 507 about an axis, parallel to the z-axis and positioned at the right edge 504b of the LED 504, through an angle of 90°.

The injector 500 may sit in a recess 506 on the edge of the lightguide 502 that conforms to the shape of the injector 500.

Another embodiment of confinement curve injector 600 for coupling light from an LED die 604 into a lightguide 602 is schematically illustrated in FIG. 6. In this embodiment, the injector 600 is positioned by a corner of the lightguide 602. The injector 600 may be coupled to the lightguide 602 via an air gap, via directly contacting surfaces or via an intermediate coupling material.

In this embodiment, the injector 600 is formed from three parts. The first part 600a corresponds to a shape produced by rotating a confinement curve 607 about an axis that is parallel to the z-axis (parallel to the confinement direction) and positioned at the left edge 604a of the LED 604. The second part 600b corresponds to a shape produced by translating the confinement curve 607 in a direction at an angle to both the x-axis and the y-axis, along the width of the LED 604. The third part 600c corresponds to a shape produced by rotating the confinement curve 607 about an axis, parallel to the z-axis and positioned at the right edge 604b of the LED 604. In the illustrated embodiment, the first part 600a corresponds to the confinement curve 607 being rotated about an axis through an angle of 45°, the second part 600b corresponds to a shape produced by translating the confinement curve in a direction at 45° to both the x- and y-axes, and the third part 600c corresponds to the confinement curve 607 being rotated about an axis through an angle of 45°. It will be appreciated that other shapes of injector may be produced by selecting different values of angles.

The corner of the lightguide 602 is referred to as a cut corner, since the two edges of the lightguide forming the corner do not meet at an apex, but are instead separated by a lightguide input surface 606. In the illustrated embodiment the lightguide input surface 606 is curved to conform to the shape of the injector 600.

Another embodiment of an injector 700 that may be used for injecting light into a cut corner of a lightguide 702 is schematically illustrated in FIG. 7. An LED die 704 is optically attached to the input face of injector 700, and the output face of the injector 700 is attached to the corner of the lightguide 702. The light from the LED 704 may be coupled from the injector 700 to the lightguide 702 through air or some other intermediate material, or may be coupled directly from the injector 700 into the lightguide 702 when the injector 700 is in contact with the lightguide 702. The injector 700 may be coupled to the lightguide 702 via an air gap, via directly contacting surfaces or via an intermediate coupling material.

In this embodiment, the shape of the injector 700 corresponds to a confinement curve 706 that has been translated in a direction, shown by the arrow 708 that lies at an angle to the x- and y-axes. In some embodiments, the arrow 708 may lie at 45° to both the x- and y-axes. The shape 710 corresponding to the translated confinement curve is shown in dotted lines. The injector 700 is formed by cutting the corners of the shape 710 between the edges of the LED 704 and the corresponding edges of the lightguide 702.

The output surface of the injector 700 may conformally match to the lightguide input surface 712 of the lightguide 700. The input surface 712 is formed at a cut corner of the lightguide 700.

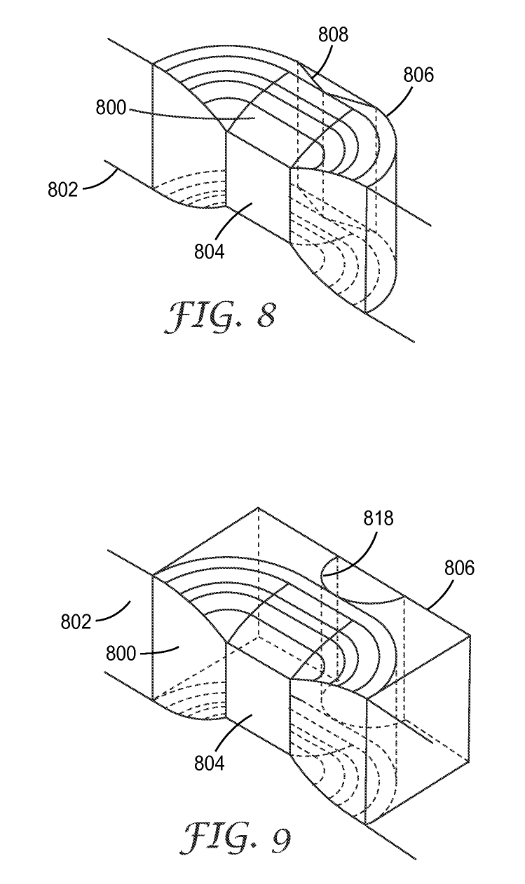

The output face of a confinement curve injector may be shaped to enhance the spreading of light within the lightguide. One embodiment of such an injector 800 is schematically illustrated in FIG. 8, positioned for coupling light from an LED 804 to a lightguide 802. This embodiment of the injector is similar to that illustrated in FIG. 5, except that the injector's output surface 806 is provided with a refractive structure 808, in the form of a v-notch.

Another embodiment of refractive structure 818 provided on an output surface 806 is schematically illustrated in FIG. 9. In this embodiment, the refractive structure 818 is in the form of a semi-cylindrical notch.

The refractive structures 808 and 818 may be in the form of air gaps between the injector and the lightguide or may be filled with a material having a refractive index different from that of air. For example, the refractive structures 808, 818 may be filled with a polymer, adhesive or the like.

### CALCULATED EXAMPLES

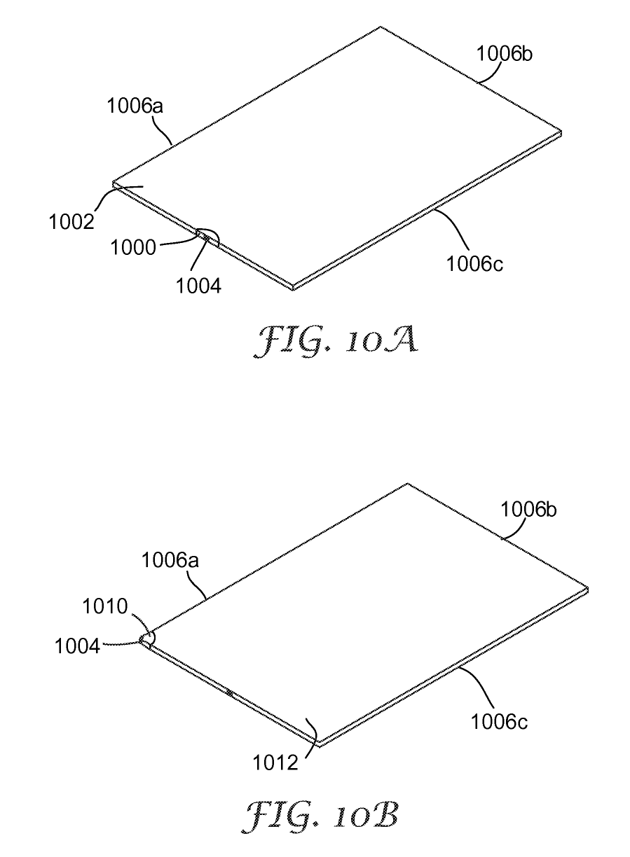

Several different embodiments of confinement curve injectors were modeled to explore the relative efficacies of different designs and to compare the use of an injector to a system having no confinement curve injector. The model for edge-coupling is schematically illustrated in FIG. 10A, in which a confinement curve injector 1000 coupled light from an LED 1004 into the edge of a lightguide 1002. The lightguide 1002 was assumed to be 30 mm×40 mm×0.5 mm thick and had a refractive index of 1.5. The spreading of light within the lightguide was modeled using TracePro™ software. The sides 1006a, 1006b and 1006c were assumed to be 100% absorbing. Thus, the power incident on the top surface of the lightguide characterizes the spreading of light within the lightguide medium without the confounding addition of light reflected from the sides. The absorption on sides 1006a, 1006b, 1006c accounts for the injected light confined within the lightguide.

The model for corner-coupling from an injector 1010 into a lightguide 1012 is schematically illustrated in FIG. 10B. The dimensions of the lightguide 1012 are the same as for the lightguide 1002 shown in FIG. 10A.

In both cases, the light was assumed to be emitted with a Lambertian profile within the injector. The injector was modeled with a refractive index of 1.7. That part of the input face of the injector surrounding the LED 1004, through which light was assumed not to enter the injector 1000, 1010, and referred to as the “back wall”, was assumed to be i) an uncoated reflecting surface (referred to as a Fresnel reflector), ii) coated to have a reflection of 98.5%, or iii) a 100% absorbing surface. In the cases of a corner injector, there was no input face outside the area of the attached LED 1004. Coupling between the injector 1000, 1010 and the lightguide 1002, 1012 was assumed to be either through a 0.001 mm air gap or through directly contacting surfaces.

Three parameters presented in the results below relate to how the light from the LED 1004 is distributed in the lightguide system. The term “injection” refers to the fraction of the incident light power that is absorbed at surfaces 1006a, 1006b, 1006c of the lightguide. The term “reabsorption” refers to the fraction of the incident light that is re-absorbed in the LED 1004. The LED 1004 was assumed to be 100% absorbing for incident light. The term “escape” refers to the fraction of light that leaks out of the confinement curve injector 1000, 1010. In each case, the sum of the percentages for injection, reabsorption and escape is equal to 100%.

### Examples 1 and 2

Examples 1 and 2 were both semicircular injectors mounted at the lightguide edge, as shown in FIG. 4. In both Examples, the back wall was assumed to have a reflectivity of 98.5%. In Example 1, the injector 1000 coupled to the lightguide 1002 through an air gap and in Example 2, the coupling was direct.

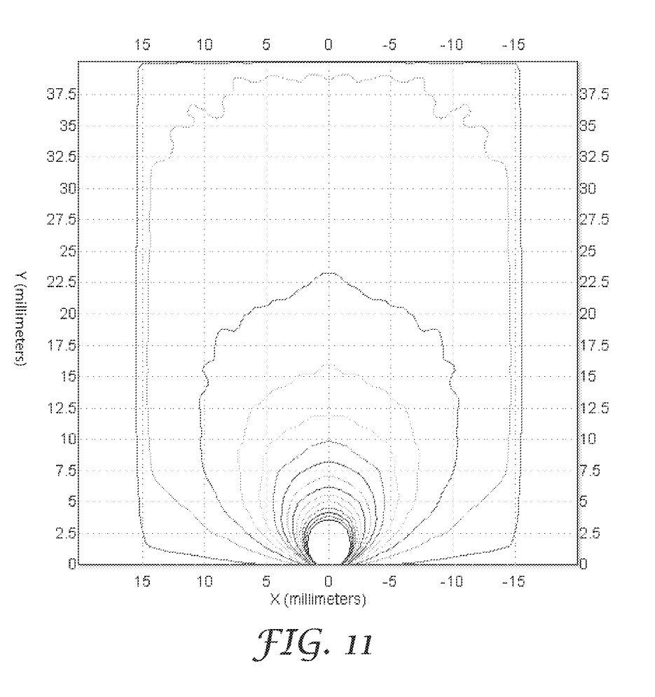

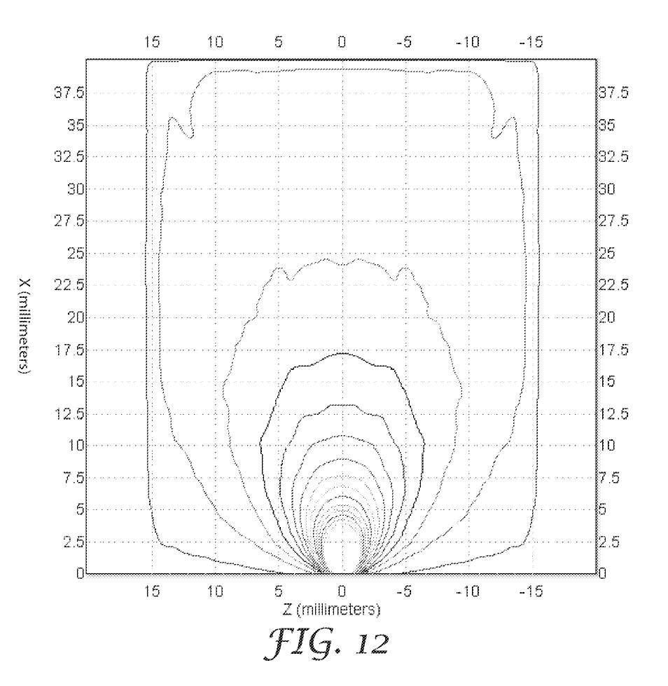

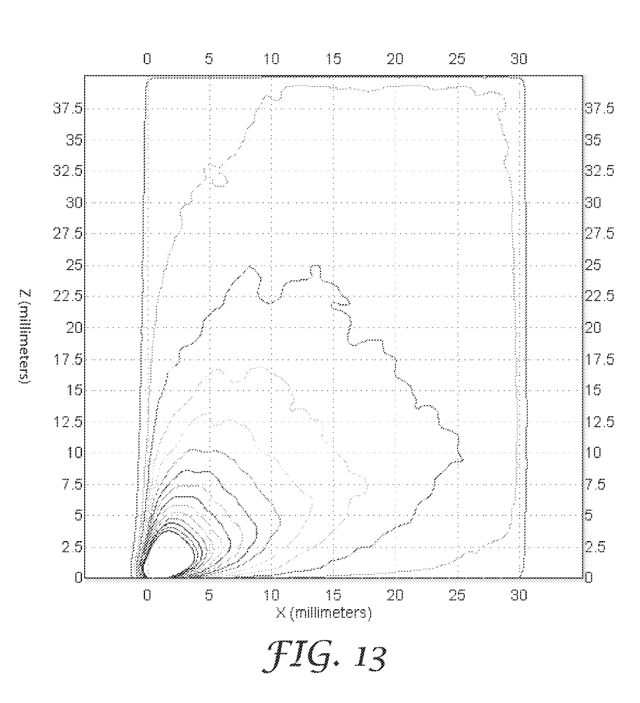

The calculated profile for the optical power incident at the top surface of the lightguide 1002 for Example 1 is shown in FIG. 11. In this figure, and in the following contour plots in FIGS. 12-17, the outermost contour corresponds to an incident light intensity of 10³ W m⁻², with each next contour representing an increase in the intensity of 3.5×10³ W m⁻².

### Examples 3-5

Examples 3-5 were based on an injector referred to as a stretched semicircle, shown schematically in FIG. 5. In Examples 3 and 4 the back wall was assumed to provide only Fresnel reflection, while in Example 5 the back wall was assumed to have a reflectivity of 98.5%. In Example 3 the coupling from the injector 1000 to the lightguide 1002 was assumed to be through directly contacted surfaces, whereas the coupling was assumed to be through an air gap in Examples 4 and 5.

The calculated profile for the optical power incident at the top surface of the lightguide 1002 for Example 3 is shown in FIG. 12.

### Examples 6 and 7

Examples 6 and 7 were based on an injector referred to as a stretched corner, shown schematically in FIG. 6. In Example 6 the coupling from the injector 1010 to the lightguide 1012 was assumed to be through directly contacted surfaces, whereas the coupling was assumed to be through an air gap in Example 7.

The calculated profile for the optical power incident at the top surface of the lightguide 1002 for Example 6 is shown in FIG. 13.

### Examples 8 and 9

Examples 8 and 9 were based on an injector referred to as a straight corner, shown schematically in FIG. 7. In Example 8 the coupling from the injector 1010 to the lightguide 1012 was assumed to be through directly contacted surfaces, whereas the coupling was assumed to be through an air gap in Example 9.

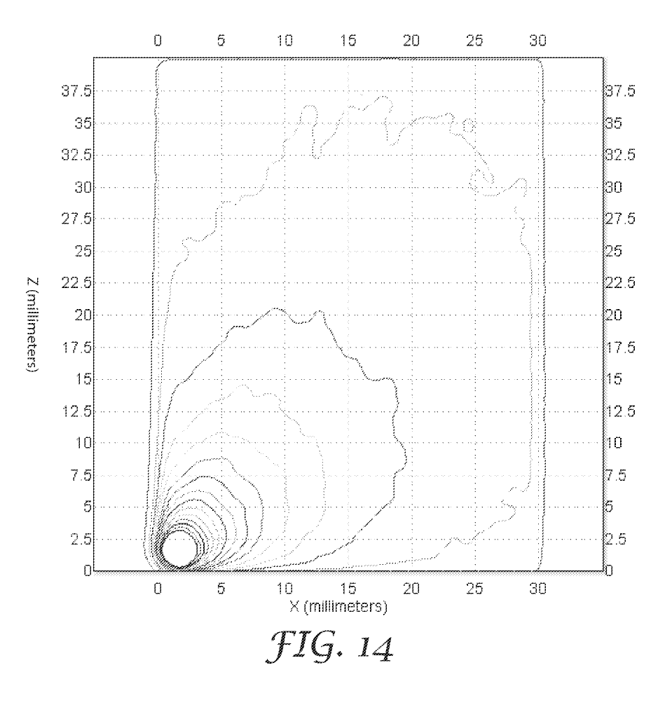

The calculated profile for the optical power incident at the top surface of the lightguide 1002 for Example 8 is shown in FIG. 14.

### Examples 10 and 11

Examples 10 and 11 were based on a stretched semicircle injector referred having a V-notched output face, as is shown schematically in FIG. 8. In Example 10 the coupling from the injector 1000 to the lightguide 1002 was assumed to be through directly contacted surfaces, whereas the coupling was assumed to be through an air gap in Example 11. Also, the back wall in Example 10 was assumed to be a 98.5% reflector while it was assumed to be a Fresnel reflector in Example 11

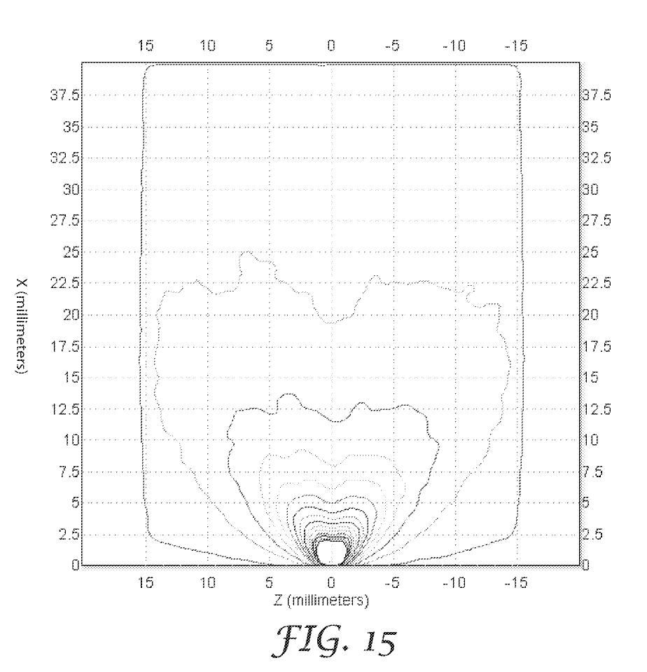

The calculated profile for the optical power incident at the top surface of the lightguide 1002 for Example 10 is shown in FIG. 15.

### Examples 12 and 13

Examples 12 and 13 were based on a stretched semicircle injector referred having a cylindrically lensed output face, as is shown schematically in FIG. 9. The coupling between the injector 1000 and the lightguide 1002 was assumed to be through directly contacted surfaces in both cases. In Example 12 the back wall was assumed to be a Fresnel reflector and in Example 13 the back wall was assumed to be a 100% absorber.

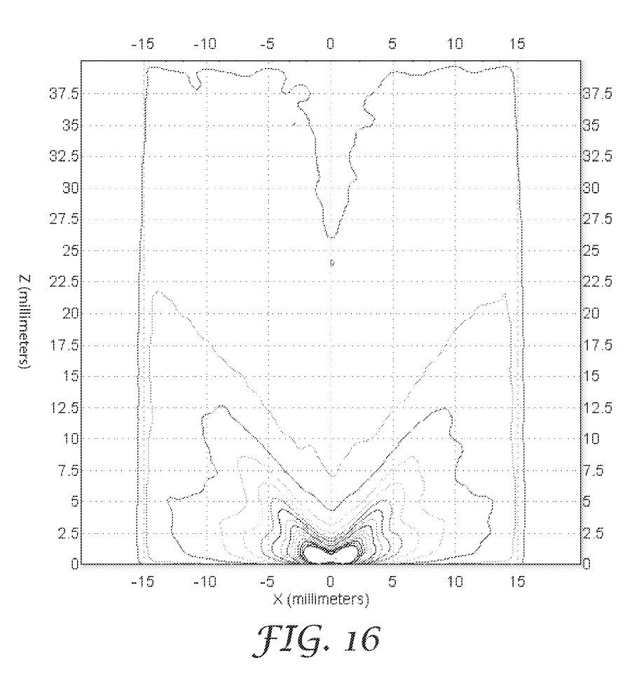

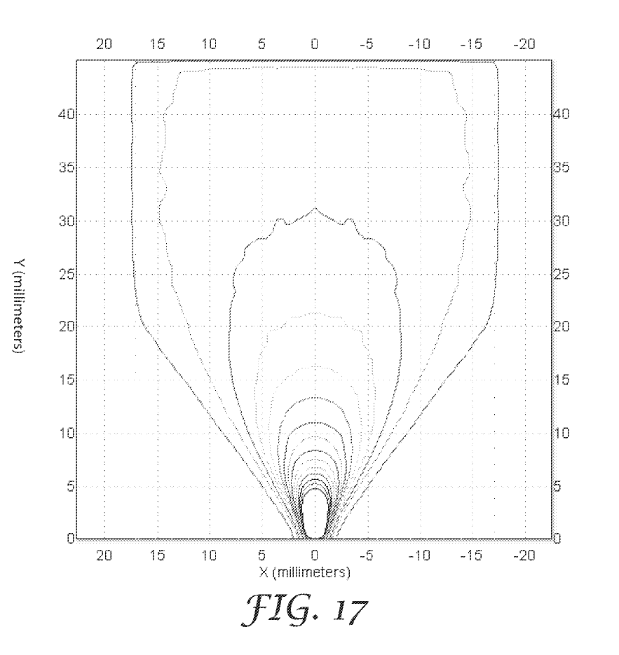

The calculated profile for the optical power incident at the top surface of the lightguide 1002 for Example 12 is shown in FIG. 16.

### Example 14—Comparative

Example 14 modeled the coupling of an LED 1004 directly to the edge of a lightguide 1002 without the use of a confinement curve injector. The calculated profile for the optical power incident at the top surface of the lightguide 1002 for Example 14 is shown in FIG. 17. The near corners exhibit no incident power, hence those regions remain dark. The propagation divergence cone has a half-width equal to the critical angle for the lightguide, which extends the mixing zone of this system. As a result, this system requires a longer lightguide than the other examples in order to achieve an area of similar size where the light extends over the entire width of the lightguide.

Various parameters and modeling results for Examples 1-14 are presented in Table I below.

TABLE I
Parameters and results for model examples.

| | | | Cou- | In- | Re- | Es- |
|---|---|---|---|---|---|---|
| Ex. | Type | Back Wall | pling | jection | abs | cape |
| 1 | Semicircle | R = 98.5% | air | 78% | 15.6% | 6.4% |
| 2 | Semicircle | R = 98.5% | direct | 93.8% | 0.0% | 6.2% |
| 3 | Stretched | Fresnel | direct | 97.4% | 0.1% | 2.5% |
| | Semicircle | | | | | |
| 4 | Stretched | Fresnel | air | 82.5% | 6.2% | 11.4% |
| | Semicircle | | | | | |
| 5 | Stretched | R = 98.5% | air | 89.2% | 7.2% | 3.4% |
| | Semicircle | | | | | |
| 6 | Stretched Corner | none | direct | 97.4% | 0.0% | 2.6% |
| 7 | Stretched Corner | none | air | 75.5% | 9.7% | 14.7% |
| 8 | Straight Corner | none | direct | 97.1% | 0.0% | 2.9% |
| 9 | Straight Corner | none | air | 55.8% | 3.7% | 40.6% |
| 10 | V-Notch Lens | R = 98.5% | direct | 95.9% | 0.0% | 3.9% |
| 11 | V-Notch Lens | Fresnel | air | 75.7% | 5.2% | 19.1% |
| 12 | Cylinder Notch | Fresnel | direct | 93.9% | 0.0% | 6.1% |
| 13 | Cylinder Notch | A = 100% | direct | 91.6% | 2.7% | 5.6% |
| 14 | Lambertiannone | air | NA | NA | NA | |
| | Source | | | | | |

As can be seen from the results presented in Table I, there is generally more light injected into the lightguide when the confinement curve injector is directly coupled to the lightguide than when there is an air gap. Also, the presence of an air gap permits some of the light to be totally internally reflected at the gap interface, which results in an increase in the amount of light re-absorbed in the LED. Some of the confinement curve injector designs result in a very high fraction of the emitted LED light being injected into the lightguide.

Other designs of confinement curve lightguide may be used. It is possible that other designs of confinement curve lightguide may inject a higher fraction of the LED light into the lightguide than the designs described here.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical system, comprising:
a lightguide having a confinement direction;
a first light source disposed proximate a periphery of the lightguide, light from the first light source being directed substantially around an emission axis, the emission axis being perpendicular to the confinement direction; and
a first light injector disposed to couple light from the first light source into the lightguide, the first light injector having a surface formed with a confinement curve for confining light in the confinement direction, and being disposed at one of a recess on the periphery of the lightguide and a cut corner of the lightguide.

2. A system as recited in claim 1, wherein the lightguide has an edge comprising a light coupling section shaped to receive the first light injector.

3. A system as recited in claim 2, wherein the light coupling section comprises a notch in a side of the lightguide, the first light injector having an output surface substantially conforming in shape to the notch of the lightguide.

4. A system as recited in claim 2, wherein the light coupling section comprises a cut at a corner of the lightguide, the first light injector comprising a surface matched to the cut corner of the lightguide.

5. A system as recited in claim 1, wherein lightguide is formed with a confinement curve rotated about an axis parallel to the confinement direction.

6. A system as recited in claim 5, wherein the injector is formed of a first section having a shape corresponding to the confinement curve being rotated about a first axis parallel to the confinement direction, a second section having a shape corresponding to the confinement curve being translated in a direction perpendicular to the confinement direction and a third section having a shape corresponding to the confinement curve being rotated about a second axis parallel to the confinement direction, the second section being positioned between the first and third sections.

7. A system as recited in claim 6, wherein at least a portion of an output face of the second section is substantially perpendicular to the emission axis.

8. A system as recited in claim 6, wherein an output face of the second section has at least one surface portion disposed non-perpendicularly relative to the emission axis.

9. A system as recited in claim 6, wherein the confinement curve of the first section is rotated by 90° about the axis parallel to the confinement direction and the confinement curve of the third section is rotated by 90° about the axis parallel to the confinement direction, the first light injector being disposed along an edge of the lightguide.

10. A system as recited in claim 6, wherein the confinement curve of the first section is rotated by 45° about the axis parallel to the confinement direction and the confinement curve of the third section is rotated by 45° about the axis parallel to the confinement direction, the first light injector being disposed at a corner of the lightguide.

11. A system as recited in claim 5, wherein the output face of the first injector is substantially semicircular and is located in a semicircular notch of the lightguide.

12. A system as recited in claim 1, wherein the first light injector has a substantially flat output surface that is matched to a substantially flat portion at a cut corner of the lightguide.

13. A system as recited in claim 12, wherein the flat portion of the cut corner is at 45° relative to edges of the lightguide.

14. A system as recited in claim 1, further comprising a refractive structure disposed between the first injector and the lightguide.

15. A system as recited in claim 14, wherein the refractive structure is formed as a notch on the output surface of the first injector.

16. A system as recited in claim 14, wherein the refractive structure comprises two flat surfaces disposed at different angles relative to the emission axis.

17. A system as recited in claim 14, wherein the refractive structure comprises a curved surface.

18. A system as recited in claim 1, wherein the first light source comprises a light emitting diode (LED).

19. A system as recited in claim 18, wherein the first light source further comprises a phosphor disposed so as to convert at least some of the light emitted by the LED at a first wavelength to light at a second wavelength different from the first wavelength.

20. A system as recited in claim 1, further comprising a display panel disposed beside the lightguide, light from the lightguide illuminating a back side of the display panel.

21. A system as recited in claim 20, further comprising one or more light management films disposed between the lightguide and the display panel and a reflector, the lightguide being disposed between the reflector and the light management films.

22. A system as recited in claim 20, further comprising a controller coupled to control an image displayed by the display panel.

23. A system as recited in claim 1, further comprising second light source and a second confinement curve injector coupling light between the second light source and the lightguide.

24. An optical system, comprising:
a first light emitting diode capable of emitting light generally about an emission axis;
a lightguide having a confinement direction substantially perpendicular to the emission axis;
a first injector coupling light from the first light emitting diode to the lightguide, the first injector having confinement curve-shaped surfaces shaped so as to confine light in a direction parallel to the confinement direction of the lightguide; and
a refractive structure disposed between the first injector and the lightguide, the refractive structure having at least one surface non-perpendicular to the emission axis of the light emitting diode.

25. An optical system as recited in claim 24, wherein the refractive structure has at least two flat surfaces disposed non-perpendicular to the emission axis.

26. An optical system as recited in claim 24, wherein the refractive structure has at least one curved surface.

27. An optical system as recited in claim 24, wherein the refractive structure is air filled.

28. An optical system as recited in claim 24, wherein the first injector has no sides having a confinement curve for confining light in a direction orthogonal to the confinement direction.

29. An optical system, comprising:
a first light emitting diode capable of emitting light generally about an emission axis;
a lightguide having a confinement direction substantially perpendicular to the emission axis;
a first injector coupling light from the first light emitting diode to the lightguide, the first injector having confinement curve-shaped surfaces shaped so as to confine light in a direction parallel to the confinement direction of the lightguide, at least a portion of the first injector having a shape corresponding to a confinement curve that is rotated about an axis parallel to the confinement direction.

30. An optical system as recited in claim 29, wherein the first injector comprises a first section having a shape corresponding to the confinement curve being rotated about a first axis parallel to the confinement direction, a second section having a shape corresponding to the confinement curve being translated in a direction perpendicular to the confinement direction and a third section having a shape corresponding to the confinement curve being rotated about a second axis parallel to the confinement direction, the second section being positioned between the first and third sections.

31. A system as recited in claim 30, wherein at least a portion of an output face of the second section is substantially perpendicular to the emission axis.

32. A system as recited in claim 30, wherein an output face of the second section has at least one surface portion disposed non-perpendicularly relative to the emission axis.

33. A system as recited in claim 30, wherein the confinement curve of the first section is rotated by 90° about the axis parallel to the confinement direction and the confinement curve of the third section is rotated by 90° about the axis parallel to the confinement direction, the first light injector being disposed along an edge of the lightguide.

34. A system as recited in claim 30, wherein the confinement curve of the first section is rotated by 45° about the axis parallel to the confinement direction and the confinement curve of the third section is rotated by 45° about the axis parallel to the confinement direction, the first light injector being disposed at a corner of the lightguide.
